(19) United States
(12) Patent Application Publication
(10) Pub. No.: US 2006/0009583 A1
(43) Pub. Date: Jan. 12, 2006

(54) Method of producing (meth) acrylic acid derivative polymer for resist

(76) Inventors: Naotaka Kubota, Kawasaki-shi (JP); Takeshi Iwai, Kawasaki-shi (JP); Hideo Hada, Kawasaki-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/535,933

(22) PCT Filed: Dec. 1, 2003
(86) PCT No.: PCT/JP03/15348

§ 371 Date: May 20, 2005

(30) Foreign Application Priority Data
Dec. 2, 2002 (JP) 2002-350352

(51) Int. Cl. C08L 33/10; B05D 3/02; B32B 27/30

(52) U.S. Cl. 525/191; 427/385.5; 428/522

(57) ABSTRACT

There is provided a photoresist composition capable of forming a resist pattern with minimal LER, and a method of forming a resist pattern. This method is a method of producing a (meth)acrylic acid derivative polymer for use as a resist by radical polymerization of a monomer mixture comprising (a1) a (meth)acrylate ester with an acid dissociable, dissolution inhibiting group, and (a2) a (meth)acrylate ester with a lactone unit, wherein (a1) and (a2) utilize compounds such that when each compound (a1) and (a2) is individually subjected to homopolymerization, under identical conditions to the radical polymerization, and a residual monomer ratio is determined 10 minutes after the start of the homopolymerization, the difference between the minimum residual monomer ratio and the maximum residual monomer ratio is no more than 15 mol %.

### TECHNICAL FIELD

The present invention relates to a method of manufacturing a (meth)acrylic acid derivative polymer for a resist with improved line edge roughness (LER).

### BACKGROUND ART

Until recently, polyhydroxystyrenes or derivatives thereof in which the hydroxyl groups are protected with an acid dissociable, dissolution inhibiting group, which display high transparency relative to a KrF excimer laser (248 nm), have been used as the substrate resin component of chemically amplified resists.

However, in recent years, the miniaturization of photoresist patterns is progressing ever more rapidly, and the development of actual production line processes using ArF excimer lasers (193 nm) is being vigorously pursued.

For processes using an ArF excimer laser as the light source, resins comprising a benzene ring such as the polyhydroxystyrenes described above have insufficient transparency relative to the ArF excimer laser (193 nm).

As a result, resins capable of resolving the above problems, with no benzene ring but comprising a structural unit within the principal chain derived from a (meth)acrylate ester with a polycyclic hydrocarbon group such as an adamantane skeleton provided at the ester section, thereby offering excellent dry etching resistance, are attracting considerable interest, and many materials have already been proposed (for example, see the patent reference 1).

However, the line edge roughness (LER) of a resist has a large effect on the performance and the yield of a semiconductor device. Line edge roughness describes non-uniform irregularities along the side walls of lines.

As the miniaturization of device pattern sizes has progressed, the effect of LER on the pattern has become relatively more significant, and in processes using ArF excimer lasers, this LER problem will be even more important than in conventional processes using KrF excimer lasers.

Generally, manufacturers have understood that increasing the diffusion length of the acid (the degree of diffusion and permeability of the acid within the resist) is one method of resolving LER. Furthermore, some improvement is also seen in LER by mixing low molecular weight polymers, and controlling the dispersibility of the base resin. However, these techniques have a trade-off in terms of a reduction in fine resolution.

(Patent Reference 1)
Japanese Unexamined Patent Application, First Publication No. Hei 9-73173

However, in conventional photoresist compositions, although improvements in LER are becoming more important as resist patterns become ever finer, satisfactory reductions in LER have proven difficult to achieve. In particular, a photoresist composition capable of reducing LER to a level that enables further miniaturization of resist patterns with no deterioration in the fine resolution or pattern shape of the resist pattern has been keenly sought.

### DISCLOSURE OF THE INVENTION

Accordingly, an object of the present invention is to provide a photoresist composition capable of forming a resist pattern with minimal LER, and a method of forming such a resist pattern.

The present invention includes a method of producing a (meth)acrylic acid derivative polymer for use as a resist composition, a (meth)acrylic acid derivative polymer for use as a resist composition, a positive type resist composition, and a method of forming a resist pattern.

In other words, a method of producing a (meth)acrylic acid derivative polymer for use as a resist composition according to the present invention is a method comprising radical polymerization of a monomer mixture comprising
(a1) a (meth)acrylate ester with an acid dissociable, dissolution inhibiting group, and
(a2) a (meth)acrylate ester with a lactone unit,
   wherein as said (a1) and (a2) compounds are utilized such that when each compound (a1) and (a2) is individually subjected to homopolymerization, under identical conditions to said radical polymerization, and residual monomer ratios of the compound (a1) and (a2) are determined 10 minutes after a start of said homopolymerization, a difference between the minimum residual monomer ratio and the maximum residual monomer ratio is no more than 15 mol %.

Furthermore, a (meth)acrylic acid derivative polymer for use as a resist composition according to the present invention is obtainable by the above production method.

Furthermore, a positive type resist composition according to the present invention comprises (A) a (meth)acrylic acid derivative polymer as described above, (B) an acid generator component that generates acid on exposure, and (C) an organic solvent.

Furthermore, a method of forming a resist pattern according to the present invention comprises the steps of applying a positive type photoresist composition of the present invention to a substrate, conducting a prebake, performing selective exposure, conducting subsequent PEB (post exposure baking), and then performing alkali developing to form a resist pattern.

According to a method of producing a (meth)acrylic acid derivative polymer for use as a resist composition according to the present invention, the LER of a resist pattern formed using the thus obtained polymer is reduced.

### BRIEF DESCRIPTION OF THE DRAWINGS

FIG. 1 is a diagram showing the relationship between the polymerization time and the residual monomer ratio within the reaction system for a variety of different monomer polymerization reactions.

### BEST MODE FOR CARRYING OUT THE INVENTION

As follows is a more detailed description of the present invention.

The resin component (polymer) of a resist composition suited to processes that use excimer lasers typically uses a hydrophobic monomer with a group such as an adamantyl group in order to achieve good acid dissociation, transparency, and etching resistance. Then, in order to adjust the total polarity of the polymer, to improve the affinity with the alkali developing liquid, a monomer with a highly polar group such as a lactone or a hydroxyl group is selected as a comonomer for the copolymerization.

However, even in the cases of copolymers, if a polymer of irregular composition is produced during polymerization, then it is thought that polymers of similar composition tend to group together, causing a loss of uniformity within the resist solution, or during resist film formation.

In conventional photoresists, including the resists disclosed in the aforementioned patent reference 1, the selection of the monomers and subsequent polymerization have been carried out solely on the basis of lithography characteristics. As a result, a photoresist capable of forming a resist pattern with minimal LER has been unobtainable.

Taking the above circumstances into consideration, the inventors of the present invention targeted another technique for improving LER, and based on the premise that the existence of polymers with varying degrees of solubility in the developing liquid at the interface between the exposed sections and the unexposed sections would cause a deterioration in LER, they conducted tests aimed at improving the LER by controlling the developing liquid solubility of the resist polymers.

In other words, it is surmised that if the reaction rates of the component monomers differ, then the monomer with the highest reaction rate will polymerize preferentially, generating polymers rich in this monomer component, and these types of polymers will collect together forming blocks of this polymer, meaning that on dissolution following patterning, sections of good solubility and poor solubility will develop, leading to raise in LER.

In contrast, the inventors discovered that if polymerization is conducted using combinations of monomers with substantially the same reaction rates, then variation in the polymer composition is minimal, and consequently, the rate of dissolution following patterning can also be equalized, causing a reduction in LER.

[Method of Producing a (Meth)Acrylic Acid Derivative Polymer for Use as a Resist Composition]

In the present invention, the term “acid dissociable, dissolution inhibiting group” refers to a group that in a process for forming a resist pattern using a photoresist composition, displays an alkali dissolution inhibiting property that makes the entire (meth)acrylic acid derivative polymer alkali insoluble prior to exposure, but following exposure, dissociates under the action of acid generated by an acid generator component (B) described below, causing the entire (meth)acrylic acid derivative polymer to become alkali soluble. Accordingly, if a resist containing this type of (meth)acrylic acid derivative polymer is applied to a substrate, and the resist is exposed through a mask pattern used for forming a resist pattern, then the alkali solubility of the exposed sections increases, enabling alkali developing to be used.

In the present invention, the term “(meth)acrylic acid” refers to acrylic acid and/or methacrylic acid.

Furthermore, the term “lactone unit” is a group in which one hydrogen atom has been removed from a monocyclic or polycyclic lactone.

In a method of producing a (meth)acrylic acid derivative polymer of the present invention, the monomer mixture must comprise (a1) a (meth)acrylate ester with an acid dissociable, dissolution inhibiting group, and (a2) a (meth)acrylate ester with a lactone unit.

There are no particular restrictions on the aforementioned (a1), and typically a (meth)acrylate ester bonded to a cyclic or chain type tertiary alkyl group is used. Of these, (meth)acrylate esters bonded to cyclic alkyl groups are preferred, and specific examples include the compounds represented by the general formulas (I) to (III) shown below. 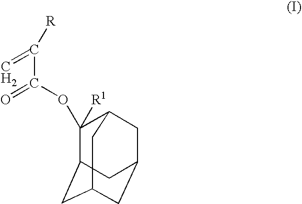
(wherein, R represents a hydrogen atom or a methyl group, and R¹ represents a lower alkyl group) 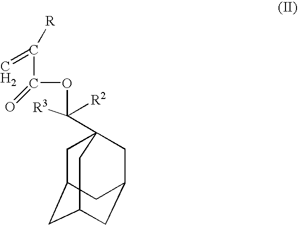
(wherein, R represents a hydrogen atom or a methyl group, and R² and R³ each represent, independently, a lower alkyl group) 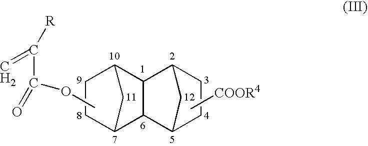
(wherein, R represents a hydrogen atom or a methyl group, and R⁴ represents a tertiary alkyl group)

The group R¹ is preferably a lower straight chain or branched alkyl group of 1 to 5 carbon atoms, and suitable examples include methyl groups, ethyl groups, propyl groups, isopropyl groups, n-butyl groups, isobutyl groups, tert-butyl groups, pentyl groups, isopentyl groups and neopentyl groups. Of these, alkyl groups of at least 2 carbon atoms, and preferably of 2 to 5 carbon atoms are preferred, and in such cases, the acid dissociability tends to increase compared with the case in which R¹ is a methyl group. Of these groups, in terms of industrial availability, methyl groups or ethyl groups are the most desirable. Specific examples include 2-methyl-2-adamantyl (meth)acrylate and 2-ethyl-2-adamantyl (meth)acrylate. The component (a1) may be either a single compound selected from the above possibilities, or a monomer mixture of two or more different compounds.

Furthermore, the groups R² and R³ each preferably represent, independently, a lower alkyl group of 1 to 5 carbon atoms. These types of groups tend to display a higher acid dissociability than a 2-methyl-2-adamantyl group.

Specifically, the groups R² and R³ represent, independently, the same types of straight chain or branched alkyl groups described above for R¹. Of these groups, the case in which R² and R³ are both methyl groups is preferred in terms of industrial availability.

Furthermore, R⁴ is a tertiary alkyl group such as a tert-butyl group or a tert-amyl group, although compounds in which R⁴ is a tert-butyl group are preferred in terms of industrial availability.

In a production method of the present invention, the use of monomers represented by the above general formula (I) is preferred.

Furthermore, there are no particular restrictions on the aforementioned (a2), and compounds selected from the (meth)acrylate esters represented by a general formula (IV) and a general formula (V) shown below are preferred. 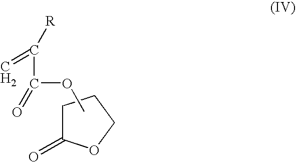
(wherein, R represents a hydrogen atom or a methyl group) 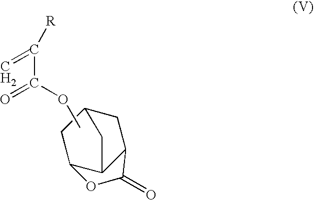
(wherein, R represents a hydrogen atom or a methyl group)

Specific examples of the aforementioned (a2) include the (meth)acrylate esters represented by structural formulas (VII), (VIII) and (IX) shown below. 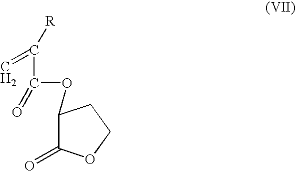
(wherein, R represents a hydrogen atom or a methyl group) 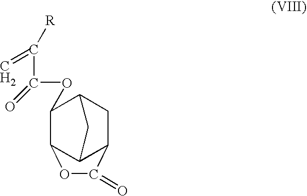
(wherein, R represents a hydrogen atom or a methyl group) 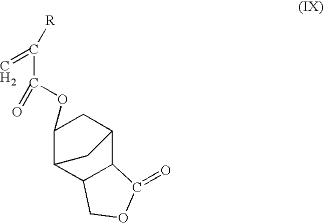
(wherein, R represents a hydrogen atom or a methyl group)

Lactone units are effective in increasing the adhesion between the resist film and the substrate, and improving the affinity with the developing liquid.

Of the above compounds, γ-butyrolactone esters of (meth)acrylic acid with an ester linkage at the α carbon atom, or norbornane lactone esters of the general formula (VIII), are particularly preferred in terms of industrial availability.

In the monomer mixture, the ratio of (a1) and (a2) is typically within a range from 2:8 to 8:2, and preferably from 3:7 to 7:3.

The aforementioned monomer mixture may comprise only (a1) and (a2), although in terms of properties such as etching resistance, resolution, and the adhesion between the resist film and the substrate, including an additional (a3) (meth)acrylate ester with a hydroxyl group is preferred when the product resin is used as a resist resin.

Because this hydroxyl group is a polar group, a (meth)acrylic acid derivative polymer produced using (a3) has an increased affinity with the developing liquid, and contributes to an improvement in the alkali solubility of the exposed sections when the polymer is used as a resist resin.

Furthermore, in addition to the monomers (a1) to (a3), if the monomer mixture also contains (a4) a (meth)acrylate ester comprising a polycyclic group with no aforementioned acid dissociable, dissolution inhibiting groups, lactone units or hydroxyl groups, then when the resin produced from the monomer mixture is used for a resist composition, the resolution for isolated patterns through to semi dense patterns (line and space patterns in which for a line width of 1, the space width is within a range from 1.2 to 2) is excellent, and is consequently preferred.

There are no particular restrictions on the aforementioned (a3), provided the compound contains a hydroxyl group on the ester side chain section, although compounds with a hydroxyl group containing polycyclic group are preferred.

Examples of such polycyclic groups include groups in which 1 hydrogen atom has been removed from a bicycloalkane, a tricycloalkane or a tetracycloalkane or the like.

Specific examples include groups in which 1 hydrogen atom has been removed from a polycycloalkane such as adamantane, norbornane, isobornane, tricyclodecane or tetracyclododecane.

The hydroxyl group containing polycyclic group described above is preferably a hydroxyl group containing adamantyl group, and a structure represented by a general formula (VI) shown below improves the dry etching resistance of the resist pattern, and the verticalness of the pattern cross-section, both of which are desirable.

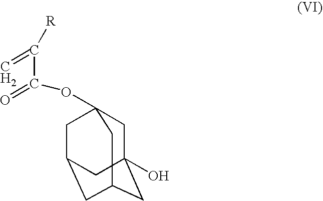

In those cases where (a3) is used, provided the (a3) content within the total monomer mixture is within a range from 1 to 40 mol %, and preferably from 1 to 30 mol %, then a good pattern can be obtained.

There are no particular restrictions on the aforementioned (a4), provided the compound cannot be classified within any of the aforementioned (a1), (a2) or (a3), and is a (meth)acrylate ester comprising an unsubstituted polycyclic group, and any of the multitude of materials conventionally used as monomers for ArF positive type resist materials can be used.

(Meth)acrylate esters with a tricyclodecanyl group, an adamantyl group or a tetracyclodecanyl group on the ester side chain are advantageous in terms of industrial availability, and specific examples of preferred esters include tricyclodecanyl (meth)acrylate, and tetracyclodecanyl (meth)acrylate.

Other copolymerizable monomers may also be added to the monomer mixture, provided such addition does not impair the effects of the present invention.

The monomer mixture used in the present invention may comprise only (a1) and (a2), although in those cases in which the mixture also contains the aforementioned (a3), (a4) or other copolymerizable monomers in addition to (a1) and (a2), the combination of (a1) and (a2) preferably accounts for at least 60 mol %, and even more preferably at least 70 mol %, and most preferably 75 mol % or greater of the total monomer mixture.

In a method of producing a (meth)acrylic acid derivative polymer for use as a resist composition according to the present invention, prior to conducting the radical polymerization of the monomer mixture, each of the monomers classified as either (a1) or (a2) is subjected to individual homopolymerization under the same conditions as the above radical polymerization, and the residual monomer ratio for the compound is determined 10 minutes after the start of polymerization. The monomer mixture is then formed from a combination of monomers in which the difference between the minimum residual monomer ratio and the maximum residual monomer ratio is no more than 15%, and preferably no more than 10% (and ideally 0%, although realistically 5% or greater). In those cases in which the component (a1) uses a plurality of monomers, or the case in which the component (a2) uses a plurality of monomers, this residual monomer ratio 10 minutes after the start of polymerization is determined for each monomer by polymerizing each monomer individually.

Furthermore, although the aforementioned (a3) and (a4) are not essential components, in those cases in which they are used, these monomers are also preferably selected so that the difference between the minimum residual monomer ratio and the maximum residual monomer ratio, across all the monomers including (a3) and (a4), is no more than 15%.

The polymerization conditions refer to the polymerization temperature, the type and concentration of the polymerization initiator, the monomer concentration levels, the polymerization atmosphere and the polymerization solvent, and the residual monomer ratio (%) 10 minutes after the start of polymerization is determined by polymerizing each monomer under conditions that are matched to the conditions used during production of the (meth)acrylic acid derivative polymer for use as a resist compositon. The monomer concentration during the polymerization used to determine the 10 minute residual monomer ratio is set to the same concentration as that of the monomer mixture during the production of a (meth)acrylic acid derivative polymer for use as a resist.

The values obtained for the residual monomer ratios 10 minutes after the start of polymerization are compared for the various monomers, and the monomers are selected so that, at least for (a1) and (a2), the difference between the monomer with the maximum residual monomer ratio 10 minutes after the start of polymerization, and the monomer with the minimum residual monomer ratio is no more than 15%.

The polymerization solvent used in the polymerization of the aforementioned monomer mixture can utilize a solvent such as tetrahydrofuran (THF), propylene glycol monomethyl ether acetate (PGMEA), and propylene glycol monomethyl ether (PGME), although THF is used in preference.

From the viewpoint of the ease with which the polymerization can be conducted (for example, the stirrability towards the end of the polymerization), the monomer concentration is preferably set within a range from 10 to 50% by weight, and even more preferably from 20 to 40% by weight, relative to the entire weight of the system.

The polymerization initiator can utilize compounds such as azobisisobutyronitrile (AIBN), azobisdimethylvaleronitrile, and tert-butyl peroxide, and of these, AIBN is used in preference.

The quantity used of the polymerization initiator will vary depending on the target molecular weight for the polymer, although typically, quantities from 5 to 30 mol % relative to the monomers are preferred.

The polymerization temperature will vary depending on the type of polymerization initiator used, although temperatures within a range from 30 to 90° C. are preferred, and values from 40 to 80° C. are even more preferred.

The polymerization atmosphere is typically an inert gas atmosphere, in order to prevent inhibition of the polymerization by oxygen.

In terms of determining the start of polymerization, either the monomer solution is raised to a predetermined temperature, and the time at which the polymerization initiator is then added is deemed the polymerization start time, or alternatively, the monomers and the polymerization initiator are first dissolved in the polymerization solvent, the temperature is raised, and the point at which a predetermined polymerization start temperature is reached is deemed the polymerization start time.

Preferred combinations of the components (a1) and (a2) include a combination of a compound of the general formula (I) in which R is a methyl group and R¹ is either a methyl group or an ethyl group, and a compound of the general formula (VII) or the general formula (VIII) in which R is a hydrogen atom; and a combination of a compound of the general formula (I) in which R is a hydrogen atom and R¹ is either a methyl group or an ethyl group, and a compound of the general formula (VII) or the general formula (VIII) in which R is a hydrogen atom.

Furthermore, preferred combinations of (a1), (a2) and (a3) include a combination of (a1) a compound of the general formula (I) in which R is a methyl group and R¹ is either a methyl group or an ethyl group, (a2) a compound of the general formula (VII) or the general formula (VIII) in which R is a hydrogen atom, and (a3) a compound of the general formula (VI) in which R is a hydrogen atom.

Furthermore, preferred combinations of (a1), (a2), (a3) and (a4) include a combination of (a1) a compound of the general formula (I) in which R is a methyl group and R¹ is either a methyl group or an ethyl group, (a2) a compound of the general formula (VII) or the general formula (VIII) in which R is a hydrogen atom, (a3) a compound of the general formula (VI) in which R is a hydrogen atom, and (a4) a compound of a general formula (X) in which R is a hydrogen atom or a methyl group. 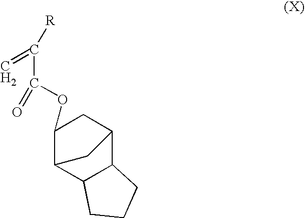
[(Meth)Acrylic Acid Derivative Polymer (a) for Use as a Resist]

A (meth)acrylic acid derivative polymer for use as a resist composition according to the present invention can be obtained using the production method described above.

A (meth)acrylic acid derivative polymer (A) for use as a resist obtained from a monomer mixture that has been selected in the manner described above displays reduced variation in composition, and is thought to suffer little variation in solubility in the developing liquid at the interface between the exposed sections and the unexposed sections, thereby enabling an improvement in LER.

[Positive Type Resist Composition]

As follows is a description of a positive type resist composition of the present invention.

A resist composition of the present invention comprises the aforementioned (meth)acrylic acid derivative polymer (A), together with an acid generator (B) that generates acid on exposure, and an organic solvent (C).

The component (B) can be appropriately selected from known materials used as acid generators in conventional chemically amplified resists.

Specific examples of the acid generator include onium salts such as diphenyliodonium trifluoromethanesulfonate, (4-methoxyphenyl)phenyliodonium trifluoromethanesulfonate, bis(p-tert-butylphenyl)iodonium trifluoromethanesulfonate, triphenylsulfonium trifluoromethanesulfonate, (4-methoxyphenyl)diphenylsulfonium trifluoromethanesulfonate, (4-methylphenyl)diphenylsulfonium nonafluorobutanesulfonate, (p-tert-butylphenyl)diphenylsulfonium trifluoromethanesulfonate, diphenyliodonium nonafluorobutanesulfonate, bis(p-tert-butylphenyl)iodonium nonafluorobutanesulfonate and triphenylsulfonium nonafluorobutanesulfonate. Of these, onium salts with a fluorinated alkylsulfonate ion as the anion are preferred.

This component (B) may utilize a single compound, or a combination of two or more compounds.

The quantity added is preferably selected within a range from 0.5 to 30 parts by weight, and even more preferably from 1 to 10 parts by weight per 100 parts by weight of the component (A). If the quantity is less than 0.5 parts by weight then there is a danger of the pattern formation not proceeding satisfactorily, whereas if the quantity exceeds 30 parts by weight, then achieving a uniform solution becomes difficult, and there is a danger of a deterioration in storage stability.

A positive type resist composition of the present invention is produced by dissolving the component (A), the component (B) and an optional component (D), which is described below, preferably in an organic solvent (C).

The organic solvent (C) can be any solvent capable of dissolving the component (A) and the component (B) to generate a uniform solution, and the solvent used can be one, or two or more solvents selected from amongst known solvents used for conventional chemically amplified resists.

Specific examples of the solvent include ketones such as acetone, methyl ethyl ketone, cyclohexanone, methyl isoamyl ketone and 2-heptanone; polyhydric alcohols and derivatives thereof such as ethylene glycol, ethylene glycol monoacetate, diethylene glycol, diethylene glycol monoacetate, propylene glycol, propylene glycol monoacetate, dipropylene glycol, or the monomethyl ether, monoethyl ether, monopropyl ether, monobutyl ether or monophenyl ether of dipropylene glycol monoacetate; cyclic ethers such as dioxane; and esters such as methyl lactate, ethyl lactate, methyl acetate, ethyl acetate, butyl acetate, methylpyruvate, ethyl pyruvate, methyl methoxypropionate, and ethyl ethoxypropionate. These organic solvents can be used singularly, or as a mixed solvent of two or more different solvents.

In particular, mixed solvents of propylene glycol monomethyl ether acetate (PGMEA) and a polar solvent containing a hydroxyl group or lactone such as propylene glycol monomethyl ether (PGME), ethyl lactate (EL) or γ-butyrolactone offer good improvement in the storage stability of the positive type resist composition, and are consequently preferred.

In those cases in which EL is added, the weight ratio of PGMEA:EL is preferably within a range from 9:1 to 1:9.

In those cases in which PGME is added, the weight ratio of PGMEA:PGME is typically within a range from 8:2 to 2:8, and preferably from 7:3 to 3:7.

Mixed solvents of PGMEA and PGME improve the storage stability of the positive type resist composition in those cases in which a component (A) which comprises all of the first (a1) through fourth (a4) structural units is used, and are consequently preferred.

In addition, mixed solvents containing at least one of PGMEA and ethyl lactate, together with γ-butyrolactone are also preferred as the organic solvent (C). In such cases, the weight ratio of the former and latter components in the mixed solvent is preferably within a range from 70:30 to 95:5. There are no particular restrictions on the quantity of the component (C), although typically, a sufficient quantity of the component (C) is added to produce a combined solid fraction concentration of 5 to 50% by weight, and preferably from 7 to 20% by weight, in accordance with the resist application film pressure.

There are no particular restrictions on the respective concentrations of the component (A), the component (B), and the component (D) described below within the component (C), and these are set to concentration levels which enable production of a positive type resist composition that can be applied to a substrate or the like.

Furthermore, in a resist composition of the present invention, in order to improve the resist pattern shape and the long term stability (the post exposure stability of the latent image formed by the pattern wise exposure of the resist layer), a secondary lower aliphatic amine or a tertiary lower aliphatic amine can also be added as a separate component (D).

Here, a lower aliphatic amine refers to an alkyl or alkyl alcohol amine of no more than 5 carbon atoms, and examples of these secondary and tertiary amines include trimethylamine, diethylamine, triethylamine, di-n-propylamine, tri-n-propylamine, tripentylamine, diethanolamine and triethanolamine, and alkanolamines such as triethanolamine are preferred.

These may be used singularly, or in combinations of two or more different compounds.

These types of amines (the component (D)) are typically added in quantities within a range from 0.01 to 2.0% by weight relative to the quantity of the component (A).

Miscible additives can also be added to a positive type resist composition of the present invention according to need, including additive resins for improving the properties of the resist film, surfactants for improving the ease of application, dissolution inhibitors, plasticizers, stabilizers, colorants and halation prevention agents.

Furthermore, a pattern formation method of the present invention can be conducted, for example, in the manner described below.

Namely, a positive type resist composition of the present invention is first applied to the surface of a substrate such as a silicon wafer using a spinner or the like, a prebake is conducted under temperature conditions of 80 to 150° C. for 40 to 180 seconds, and preferably for 60 to 90 seconds, and then following selective exposure of an ArF excimer laser through a desired mask pattern using, for example, an ArF exposure apparatus, PEB (post exposure baking) is conducted under temperature conditions of 80 to 150° C. for 40 to 180 seconds, and preferably for 60 to 90 seconds. Subsequently, developing is conducted using an alkali developing liquid such as a 0.1 to 10% by weight aqueous solution of tetramethylammonium hydroxide. In this manner, a resist pattern which is faithful to the mask pattern can be obtained.

An organic or inorganic anti-reflective film may also be provided between the substrate and the applied layer of the resist composition.

The alkali developing liquid usually employs a standard concentration of 2.38% by weight, but for the reasons described above, developing is also possible using more dilute developing liquids with a concentration within a range from 0.05 to 0.5% by weight, and the pattern shape tends to improve for concentrations within this range.

Furthermore, although a positive type resist composition of the present invention is particularly applicable to ArF excimer lasers, it is also effective for other types of radiation of shorter wavelength such as F₂ excimer lasers, EUV (extreme ultraviolet radiation), VUV (vacuum ultraviolet radiation), electron beams, X-rays and soft X-rays.

The resist film typically has a film thickness of no more than 1 μm, and is usually formed with a film thickness of 200 to 500 nm, although the increasing aspect ratios that accompany miniaturization mean that pattern collapse is becoming a significant problem for ArF excimer laser resists. One method of resolving this issue is to reduce the film thickness of the resist. However, when a thin film with film thickness of 150 to 300 nm is formed, the pattern shape may deteriorate to some extent. In those cases in which this type of thin film is to be formed, a better pattern shape can be produced by marginally increasing the quantity of the component (B) relative to the component (A), for example by 2 to 3%.

### EXAMPLES

As follows is a more detailed description of the present invention using a series of examples.

### Reference Example 1

Each of the monomers described below was used individually as the monomer.

The monomer was added to a reaction vessel containing tetrahydrofuran (THF), in sufficient quantity to generate a concentration of 30% by weight, and the monomer solution was stirred. Subsequently, the reaction vessel was heated until the internal temperature reached 60° C., and once 60° C. had been reached, a separately prepared THF solution of 2,2′-azobis(isobutyronitrile) (AIBN) was added to the monomer solution in a quantity equivalent to 10 mol % relative to the monomer, thereby starting the polymerization. Sampling was conducted at 5 minutes, 10 minutes, 15 minutes, 20 minutes, 25 minutes, 35 minutes and 60 minutes after the start of polymerization (the point where the polymerization initiator was added), and gas chromatography was used to determine the residual monomer ratio (%) in the system at each time, and these values were plotted on a graph.
Ma: methyladamantyl acrylate [A compound of the general formula (I), in which R is a hydrogen atom and R¹ is a methyl group]
Mm: methyladamantyl methacrylate [A compound of the general formula (I), in which R and R¹ are both methyl groups]
Ea: ethyladamantyl acrylate [A compound of the general formula (I), in which R is a hydrogen atom and R¹ is an ethyl group]
Em: ethyladamantyl methacrylate [A compound of the general formula (I), in which R is a methyl group and R¹ is an ethyl group]
Ga: A compound of the general formula (VII) in which R is a hydrogen atom
Gm: A compound of the general formula (VII) in which R is a methyl group
Na: A compound of the general formula (VIII) in which R is a hydrogen atom
Nm: A compound of the general formula (VIII) in which R is a methyl group
Ha: A compound of the general formula (VI) in which R is a hydrogen atom
Hm: A compound of the general formula (VI) in which R is a methyl group
Ta: A compound of the general formula (X) in which R is a hydrogen atom
Tm: A compound of the general formula (X) in which R is a methyl group

### Example 1

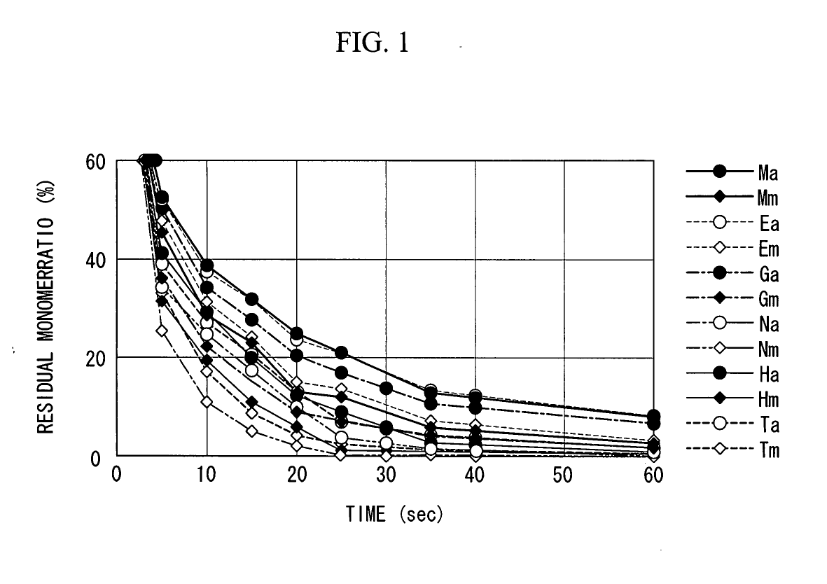

Referring to FIG. 1, a monomer mixture with a monomer composition of Em/Na/Ha=40/40/20 (molar ratio) was used, and by conducting polymerization under conditions including a polymerization solvent of THF, a monomer concentration of 30% by weight, a polymerization initiator of AIBN, a polymerization initiator concentration of 10 mol % relative to the combined monomers, an atmosphere of nitrogen, and a temperature of 60° C., a (meth)acrylic acid derivative polymer for use as a resist with a weight average molecular weight of 10,000 was obtained. Of the above monomers, Em is a methacrylate with an acid dissociable, dissolution inhibiting group, Na is an acrylate with a lactone unit, and Ha is an acrylate with a hydroxyl group, and from FIG. 1 it is evident that in terms of the residual monomer ratio 10 minutes after the start of polymerization, Em displays the highest value and Na displays the lowest value, and the difference between these two values is approximately 7%.

(A) 100 parts by weight of the thus produced (meth)acrylic acid derivative polymer for use as a resist, (B) 2.5 parts by weight of triphenylsulfonium nonafluorobutanesulfonate, and (D) 0.2 parts by weight of triethanolamine were dissolved uniformly in (C) 750 parts by weight of a mixed solvent containing propylene glycol monomethyl ether acetate/ethyl lactate in a weight ratio of 6/4, thereby forming a resist composition.

Meanwhile, an organic anti-reflective film (AR19, manufactured by Shipley Co., Ltd.) was applied to the surface of a silicon wafer, and prebaked at 215° C. for 60 seconds, thereby forming an anti-reflective film layer with a film thickness of 82 nm.

The resist composition obtained above was then applied to the anti-reflective layer coated silicon wafer using a spinner, and was then prebaked and dried at 120° C. for 90 seconds, forming a resist layer with a film thickness of 340 nm.

This layer was then selectively irradiated with an ArF excimer laser (193 nm) through a mask pattern, using an ArF exposure apparatus NSR-S302 manufactured by Nikon Corporation (NA (numerical aperture)=0.60, 2/3 annular illumination).

The irradiated resist was subjected to PEB treatment at 110° C. for 90 seconds, subsequently subjected to puddle development for 60 seconds at 23° C. in a 2.38% by weight aqueous solution of tetramethylammonium hydroxide, and was then washed for 20 seconds with water, and dried.

As a result, a 120 nm line and space pattern (1:1) was formed with good shape.

Determination of the 3σ value, which is a measure of the LER of the thus obtained line and space pattern, revealed a result of 7.4 nm.

### Comparative Example 1

With the exception of using a combination of monomers with comparatively different values for the residual monomer ratio 10 minutes after the start of polymerization, namely a combination of Ea/Nm/Ha=40/40/20 (molar ratio), a (meth)acrylic acid derivative polymer for use as a resist was prepared in the same manner as the example 1. From FIG. 1 it is evident that within this monomer combination, Ea displays the highest residual monomer ratio 10 minutes after the start of polymerization, and Nm displays the lowest value. The difference between the residual monomer ratio 10 minutes after the start of polymerization for Ea and Nm is 27%. With the exception of using this polymer, a resist composition was prepared in the same manner as the example 1. Using this resist composition, a 120 nm line and space pattern (1:1) was formed in the same manner as the example 1. The 3σ value for the thus obtained pattern was 8.6 nm.

A resist like that of the comparative example 1, which uses a (meth)acrylic acid derivative polymer formed from a monomer mixture in which the difference between the residual monomer ratios 10 minutes after the start of polymerization for the (meth)acrylate with an acid dissociable, dissolution inhibiting group and the (meth)acrylate with a lactone unit exceeds 15% displays a large LER, whereas in contrast, as can be seen from the example 1, a pattern obtained from a resist composition that utilizes a (meth)acrylic acid derivative polymer in which the difference between the residual monomer ratios 10 minutes after the start of polymerization for the (meth)acrylate monomers is less than 15% displays a reduced LER.

### INDUSTRIAL APPLICABILITY

According to a method of producing a (meth)acrylic acid derivative polymer for use as a resist according to the present invention, the LER of a resist pattern formed using the product polymer can be reduced, which is industrially useful.

1. A method of producing a (meth)acrylic acid derivative polymer for use as a resist composition, the method comprising radical polymerization of a monomer mixture comprising:
(a1) a (meth)acrylate ester with an acid dissociable, dissolution inhibiting group, and
(a2) a (meth)acrylate ester with a lactone unit,
wherein as said (a1) and (a2) compounds are utilized such that when each compound (a1) and (a2) is individually subjected to homopolymerization, under identical conditions to said radical polymerization, and residual monomer ratios of the compound (a1) and (a2) are determined 10 minutes after a start of said homopolymerization, a difference between the minimum residual monomer ratio and the maximum residual monomer ratio is no more than 15 mol %.

2. A method of producing a (meth)acrylic acid derivative polymer for use as a resist composition according to claim 1, wherein a combined total of said (a1) and said (a2) accounts for at least 60 mol % of said monomer mixture.

3. A method of producing a (meth)acrylic acid derivative polymer for use as a resist composition according to claim 1, wherein said (a1) uses at least one compound selected from a group consisting of (meth)acrylate esters represented by general formulas (I), (II) and (III) shown below: 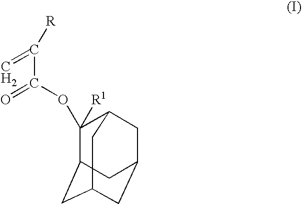
(wherein, R represents a hydrogen atom or a methyl group, and R¹ represents a lower alkyl group), 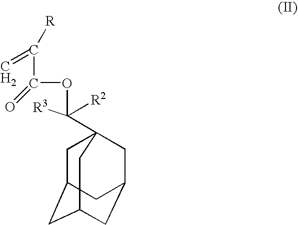
(wherein, R represents a hydrogen atom or a methyl group, and R² and R³ each represent, independently, a lower alkyl group), and 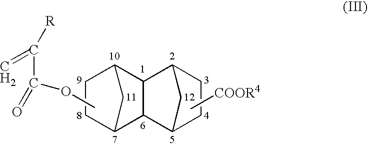
(wherein, R represents a hydrogen atom or a methyl group, and R⁴ represents a tertiary alkyl group).

4. A method of producing a (meth)acrylic acid derivative polymer for use as a resist composition according to claim 1, wherein said (a2) uses at least one compound selected from a group consisting of (meth)acrylate esters represented by general formulas (IV) and (V) shown below: 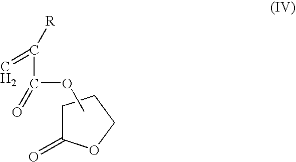
(wherein, R represents a hydrogen atom or a methyl group), and 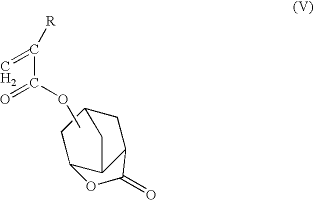
(wherein, R represents a hydrogen atom or a methyl group).

5. A method of producing a (meth)acrylic acid derivative polymer for use as a resist composition according to claim 1, wherein said monomer mixture also comprises (a3) a (meth)acrylate ester with a hydroxyl group.

6. A method of producing a (meth)acrylic acid derivative polymer for use as a resist composition according to claim 5, wherein said (a3) uses a material containing a (meth)acrylate ester represented by a general formula (VI) shown below: 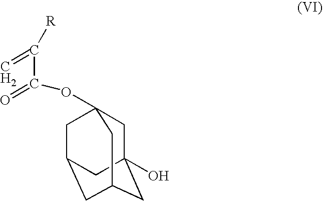
(wherein, R represents a hydrogen atom or a methyl group).

7. A method of producing a (meth)acrylic acid derivative polymer for use as a resist composition according to claim 5, wherein said monomer mixture also comprises (a4) a (meth)acrylate ester that is different from said (a1), (a2) and (a3).

8. A method of producing a (meth)acrylic acid derivative polymer for use as a resist composition according to claim 7, wherein said (a4) utilizes a material containing tricyclodecanyl (meth)acrylate.

9. A method of producing a (meth)acrylic acid derivative polymer for use as a resist composition according to claim 1, wherein said (a1) accounts for 20 to 60 mol % of a combined total of said monomer mixture.

10. A method of producing a (meth)acrylic acid derivative polymer for use as a resist composition according to claim 1, wherein said (a2) accounts for 20 to 60 mol % of a combined total of said monomer mixture.

11. A method of producing a (meth)acrylic acid derivative polymer for use as a resist composition according to claim 5, wherein said (a3) accounts for 1 to 50 mol % of a combined total of said monomer mixture.

12. A (meth)acrylic acid derivative polymer for use as a resist composition, produced using said method according to claim 1.

13. A positive type resist composition, comprising (A) a (meth)acrylic acid derivative polymer according to claim 12, (B) an acid generator component that generates acid on exposure, and (C) an organic solvent.

14. A method of forming a resist pattern comprising the steps of applying a positive type photoresist composition according to claim 13 to a substrate, conducting a prebake, performing selective exposure, conducting subsequent PEB (post exposure baking), and then performing alkali developing to form a resist pattern.

15. A method of producing a (meth)acrylic acid derivative polymer, comprising:
providing, as monomers, (a1) a (meth)acrylate ester with an acid dissociable, dissolution inhibiting group, and (a2) a (meth)acrylate ester with a lactone unit,
wherein each monomer included in components (a1) and each monomer included in component (a2) are such that when each monomer is homopolymerized under given conditions, a difference between a minimum residual monomer ratio and a maximum residual monomer ratio among the monomers of components (a1) and (a2) is no more than 15% by mole as measured 10 minutes after a start of the homopolymerization; and
conducting radical polymerization of the monomers of components (a1) and (a2), thereby obtaining the (meth)acrylic acid derivative polymer.

16. A method of producing a positive type photoresist composition, comprising:
providing the (meth)acrylic acid derivative polymer according to claim 15; and
mixting the (meth)acrylic acid derivative polymer, an acid generator component for generating acid on exposure, and an organic solvent, thereby obtaining the positive type photoresist composition.

17. A method of forming a resist pattern comprising:
providing the positive type photoresist composition according to claim 16;
applying the positive type photoresist composition to a substrate;
conducting prebaking of the substrate with the positive type photoresist composition applied thereon;
performing selective exposure of the applied positive type photoresist composition;
conducting post exposure baking (PEB) of the selectively exposed positive type photoresist composition; and
performing alkali developing of the positive type photoresist composition baked by the PEB to form a resist pattern.
